(19) United States
(12) Patent Application Publication
(10) Pub. No.: US 2013/0246378 A1
(43) Pub. Date: Sep. 19, 2013

(54) PARTIAL HASH SYSTEM, METHOD, AND COMPUTER PROGRAM PRODUCT

(71) Applicants: Stephen Owen Hearnden, Miton Keynes (GB); Anthony Vaughan Bartram, Milton Keynes (GB)

(72) Inventors: Stephen Owen Hearnden, Miton Keynes (GB); Anthony Vaughan Bartram, Milton Keynes (GB)

(21) Appl. No.: 11/742,410

(22) Filed: Apr. 30, 2007

(51) Int. Cl. G06F 17/30

(52) U.S. Cl. 707/698; 707/E17.036

(57) ABSTRACT

A system, method, and computer program product are provided for outputting a signal based on a partial hash comparison. In use, data is identified. In addition, a partial hash is determined utilizing a portion of the data. Further, the partial hash is compared with a plurality of known partial hashes, and an additional hash is conditionally determined based on the comparison. Still yet, a signal is output based on the comparison.

### FIELD OF THE INVENTION

The present invention relates to hash algorithms, and more particularly to data identification utilizing hash algorithms.

### BACKGROUND

Traditionally, hash algorithms have been utilized for generating hashes from data. The calculated hashes are generally smaller than the data from which they are generated, and may thus serve as a compact digital representation of such data. Sometimes, hashes are utilized for identifying data (as being known) by comparing a particular hash to hashes associated with known data.

However, conventional methods of identifying known data utilizing hashes have various associated limitations. For example, while the foregoing comparison technique involves compact hashes, it may nevertheless involve a large number of such hashes which, together, still require a significant amount of processing resources, duration, etc.

There is thus a need for addressing these and/or other issues associated with the prior art.

### SUMMARY

A system method, and computer program product are provided for outputting a signal based on a partial hash comparison. In use, data is identified. In addition, a partial hash is determined utilizing a portion of the data. Further, the partial hash is compared with a plurality of known partial hashes, and an additional hash is conditionally determined based on the comparison. Still yet, a signal is output based on the comparison.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for outputting a signal based on a partial hash comparison, in accordance with one embodiment.

FIG. 4 shows a system for outputting a signal based on a partial hash comparison, in accordance with one embodiment.

FIG. 5 shows a method for hashing portions of data, in accordance with one embodiment.

FIG. 6 shows a method for identifying a data file using one or more partial hashes, in accordance with one embodiment.

### DETAILED DESCRIPTION

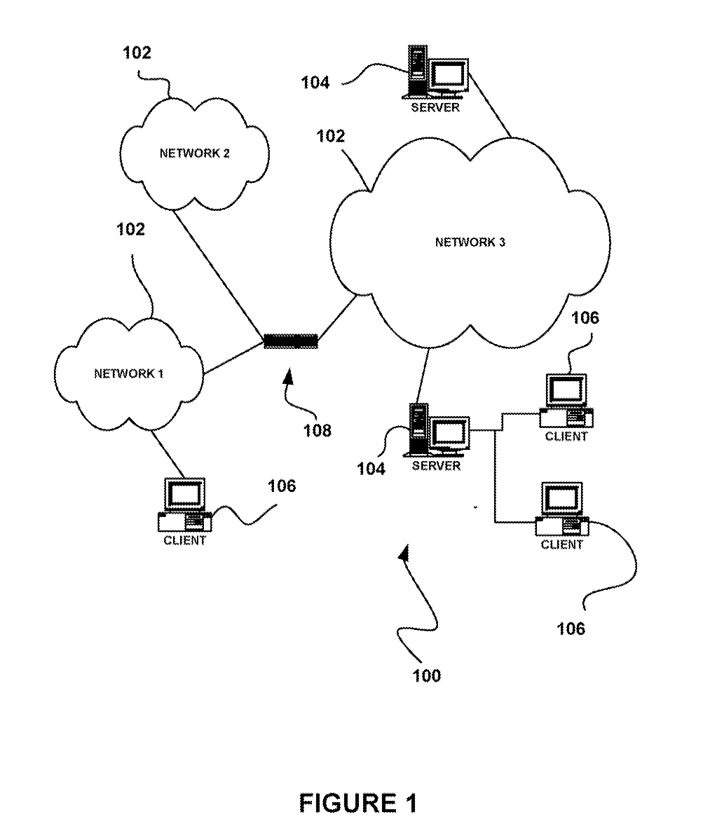

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

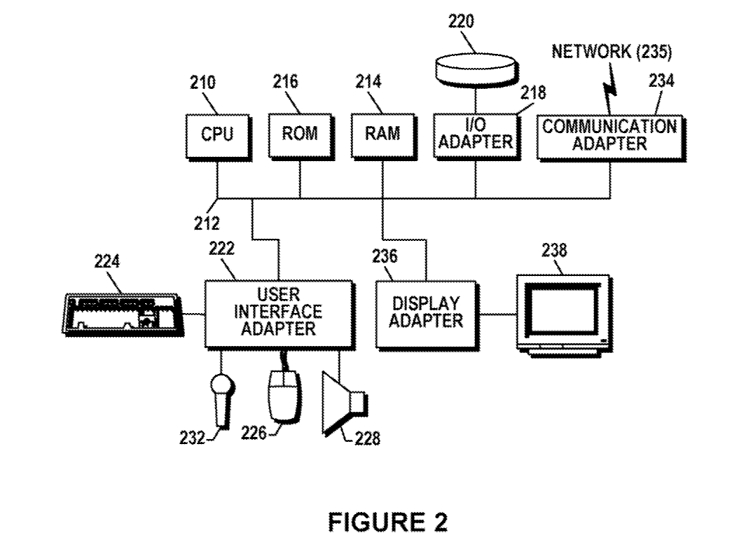

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via, a system bus 212.

The workstation shown in FIG. 2 includes a. Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system, it will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

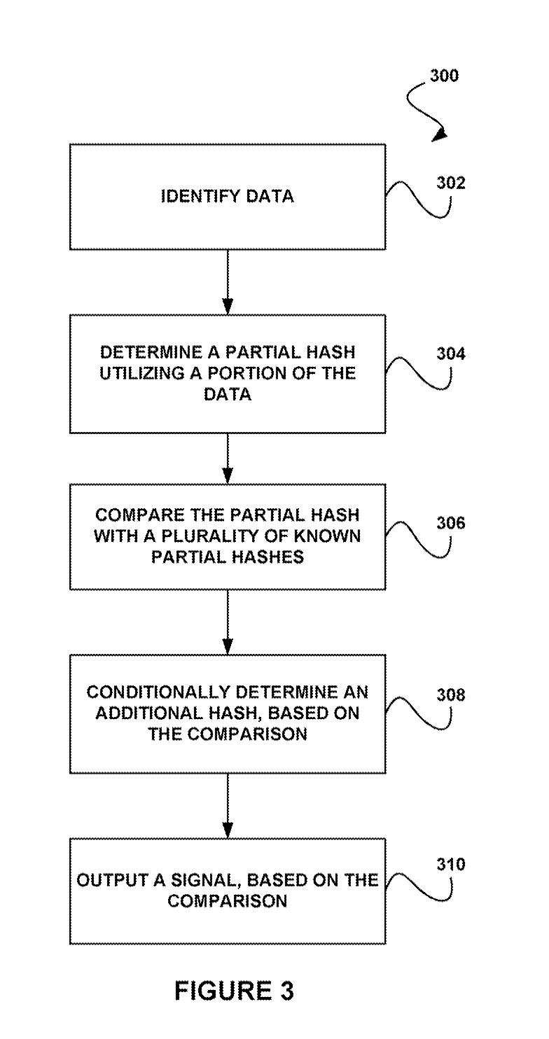

FIG. 3 shows a method 300 for outputting a signal based on a partial hash comparison, in accordance with one embodiment. As an option, the method 300 may be implemented in the context of the architecture and environment of FIGS. 1 and/or 2. Of course, however, the method 300 may be carried out in any desired environment.

As shown in operation 302, data is identified. In the context of the present description, the data may include any data of digital form capable of being identified. Just by way of example, the data may include a file, a network communication, electronic mail (email) message, etc.

In addition, the data may be identified in any desired manner. In one embodiment, for example, the data may include an email message identified in response to receipt and/or transmission thereof by an email application. In another embodiment, the data may include a system file for an operating system, an application program/data file, etc identified in response to a request for access the same.

Additionally, a partial hash is determined utilizing a portion of the data. See operation 304. In the context of the present embodiment, the partial hash may be determined utilizing any type of hash algorithm. For example, the partial hash may be determined utilizing the secure hash algorithm 1 (SHA-1), message-digest 5 algorithm (MD5), cycic redundancy check (CRC), etc. Thus, a single hash value may optionally be determined for the portion of the data.

Further, the portion of the data may refer to any subpart of the data. Thus, the portion of the data may include a section of the data, which may be of any size less than the total data size. In one optional embodiment, the data may be divided into multiple portions.

As shown in operation 306, the partial hash is compared with a plurality of known partial hashes. In the context of the present description, the known partial hashes may include any predetermined partial hashes. In one embodiment, the known partial hashes may be the same size as the partial hash.

As an option, the known partial hashes may be stored in a database. For example, such database may include an entry for each of the known partial hashes. As another example, the database may store known partial hashes in association with particular instances of known data from which the known partial hashes were generated.

In one embodiment, the known partial hashes may be generated utilizing portions of known data (e.g. files, etc). In another embodiment, the known data may be known to be associated with at least one predetermined category of data. Such category may include, for example, unwanted, confidential, etc.

To this end, the known data may be known to be unwanted, in one optional embodiment. Just by way of example, the known unwanted data may include a virus, spam, and/or any other content predetermined to be unwanted. Thus, the known partial hashes may be known to be associated with unwanted data, as an option. In another embodiment, the known data may be known to be confidential and the present comparison may be used to identify data as having such confidential status (to prevent data leakage, etc.).

Still yet, the comparison may be performed in any desired manner. For example, the determined partial hash may be compared to the known partial hashes for determining whether the determined partial hash matches any of the known partial hashes.

Further, an additional hash is conditionally determined based on the comparison. See operation 308. By way of example, in one optional embodiment, an additional hash may be determined if (and only if) the determined partial hash matches at least one of the known partial hashes. For example, a match between the determined partial hash and at least one of the known partial hashes may indicate that the data associated with the determined partial hash matches at least a portion of known data. Such situation may warrant further analysis (e.g. more hashes) to determine whether the data is known, with more certainty.

In one embodiment, the additional hash may be based on predetermined portions of the data. Just by way of example, if the partial hash is determined utilizing a first byte of the data, the additional hash may be determined utilizing the first and second bytes of the data. Thus, the additional hash may optionally include a second partial hash determined utilizing a second portion of the data. Of course, it should be noted that the additional hash may be based on any desired portion of the data, including, for example, a hash of all of the data.

In this way, the partial hash may be utilized such that determining the additional hash of the data may optionally be avoided based on the comparison (e.g. where the partial hash of the data does not match a known partial hash, thus indicating that the data does not match known data, etc.). Accordingly, resources utilized in identifying whether the data is known or unknown may be limited in situations where the partial hash of the data does not match a known partial hash.

Further, as shown in operation 310, a signal is output based on the comparison. The signal may include any signal capable of indicating a current status and/or result of the comparison of operation 306. For example, the signal may indicate that the data is at least potentially known, unknown, altered, corrupted, etc.

In one embodiment, the signal may indicate that the data is unknown if it is determined that partial hash does not match any of the known partial hashes. In another embodiment, the signal may indicate that the data is at least potentially known if it is determined that the partial hash matches at least one of the known partial hashes. Of course, however, the signal may be output in any desired manner that is based on the comparison of the partial hash with the known partial hashes.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

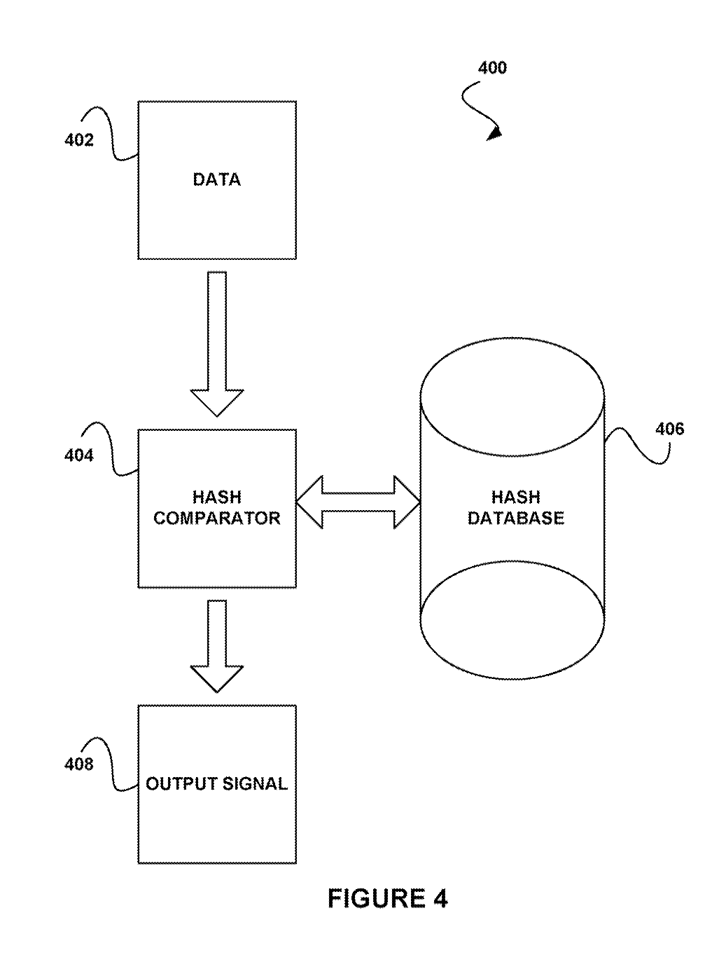

FIG. 4 shows a system 400 for outputting a signal based on a partial hash comparison, in accordance with another embodiment. As an option, the system 400 may be implemented in the context of the architecture and environment of FIGS. 1-3. Of course, however, the system 400 may be implemented in any desired environment. It should also be noted that the aforementioned definitions may apply during the present description.

As illustrated, data 402 is communicated to a hash comparator 404. In one embodiment, the data 402 may be communicated from a device. For example, such device may include any of the clients and/or servers described above with respect to FIGS. 1 and/or 2. In another embodiment, the data 402 may be communicated from an application. Optionally, the application may be capable of intercepting data (e.g. emails, etc.) being transferred, identifying data associated with an access request, etc. It should be noted that the data 402 may be communicated to the hash comparator 404 in any desired manner.

Additionally, the hash comparator 404 may include any device, module, etc. capable of performing at least a partial hash comparison. For example, the hash comparator 404 may include a processor, etc. In one embodiment, the hash comparator 404 may be integrated with a device from which the data is communicated. Of course, in another embodiment, the hash comparator 404 may be located on a device that is separate from a device from which the data is communicated.

Furthermore, the hash comparator 404 determines a partial hash utilizing the data 402. For example, the partial hash may include a hash of a portion of the data 402. Thus, the hash comparator 404 may optionally execute a hash algorithm on the portion of the data 402 for determining the partial hash.

Still yet, the hash comparator 404 receives a plurality of known partial hashes from a hash database 406 in the context of the present embodiment, the hash database may include any data structure capable of storing known partial hashes. To this end, in one embodiment, the hash database 406 may optionally store one or more known partial hashes associated with known files.

In another embodiment, the hash database 406 may include an entry for each known file. In addition, each known file may be associated with a plurality of known partial hashes, determined utilizing portions of such known file. Optionally, the plurality of known partial hashes may be stored in an array within the hash database 406. For example, a first element in the array may include a first known partial hash of the known file, a second element in the array may include a second known partial hash of the known file, etc. Further, each known file may also be associated with a known full hash calculated from the entire contents of the known file. In one embodiment, such known full hash may be included in the last element of the array.

In yet another embodiment, the hash comparator 404 may be in communication with the bash database 406 via an interface (not shown). For example, such an interface may include a transmission interface. Further, the hash comparator 404 may compare the partial hash of the data 402 to the received known partial hashes. Thus, the hash comparator 404 may determine whether the partial hash of the data 402 matches any of the known partial hashes.

Further, the hash comparator 404 transmits an output signal 408, based on the comparison of the partial hash of the data 402 with the known partial hashes. The output signal 408 may include any signal capable of indicating a status and or result of the comparison by the hash comparator 404. For example, the output signal may indicate whether a match to at least one of the known partial hashes was identified. Optionally, the output signal may be a “1” if a match to a partial hash is identified or a “0” if a match is not identified.

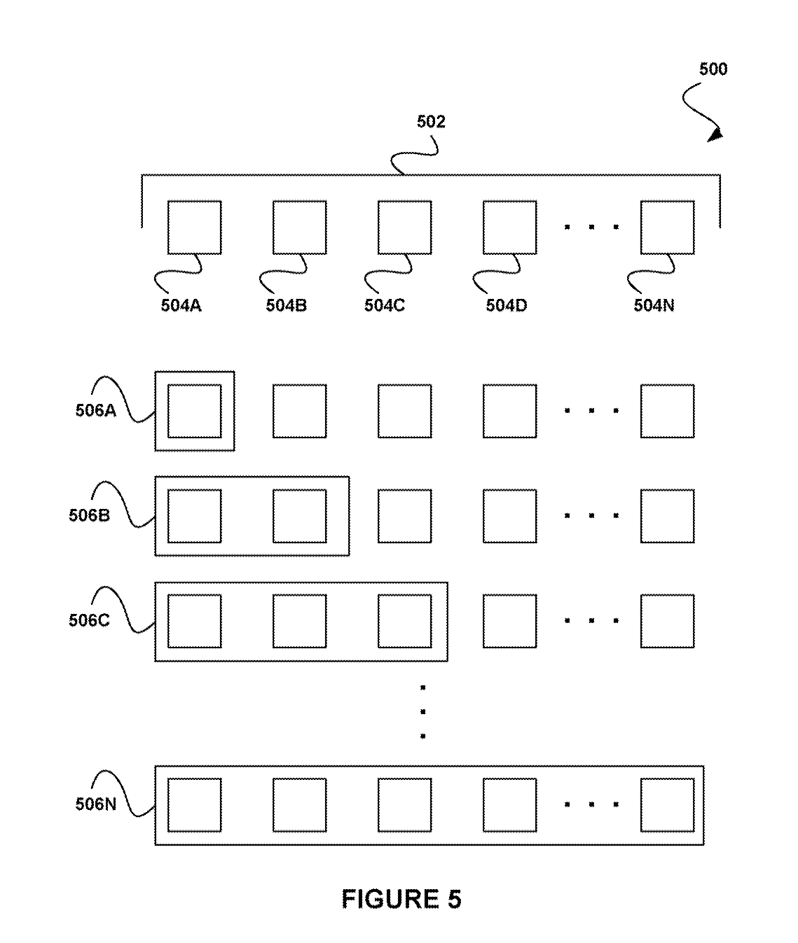

FIG. 5 shows a method 500 for bashing portions of data, in accordance with another embodiment. As an option, the method 500 may be used in the context of the architecture and environment of FIGS. 1-4. Of course, however, the method 500 may be used in any desired environment. It should also be noted that the aforementioned definitions may apply during the present description.

As illustrated, data 502 is apportioned into a plurality of segments 504A-N. In the context of the present description, the segments 504A-N may include various subparts, etc of the data 502. In one embodiment, each of the segments 504A-N may be of equal size. Of course, however, each of the segments 504A-N may also be of various different sizes.

In addition, partial hashes are calculated based on the segments 504A-N. As shown, a first partial hash is calculated from a first portion 506A of the data 502. The first portion 506A of the data 502 includes a first segment 504A. Further, a second partial hash is calculated from a second portion 5068 of the data 502, where such second portion 5068 includes the first segment 504A and a second segment 506B.

Moreover, a third partial hash is calculated from a third portion 506C of the data 502. As shown, such third portion 506C includes the first segment 504A, the second segment 504B, and a third segment 504C. Thus, each subsequent hash may be calculated based on a portion 506A-N of the data 502 that include a next segment 504A-N and all previous segments 504A-1N. Of course, it should be noted that the portions 506A-N of the data may each include any desired number of segments 504A-N, and thus are not limited to including a single next segment 504A-N, as described herein.

Still yet, a full hash is calculated from a full portion 506N of the data 502, where such full portion 506N includes all of the segments 504A-N of data 502, as shown. To this end, the full hash may be generated from the entire data 502. As an option, one or more of the partial hashes may be stored in a data structure, such as an array. For example, the elements in the array may be associated with sequential partial hashes of the data 502.

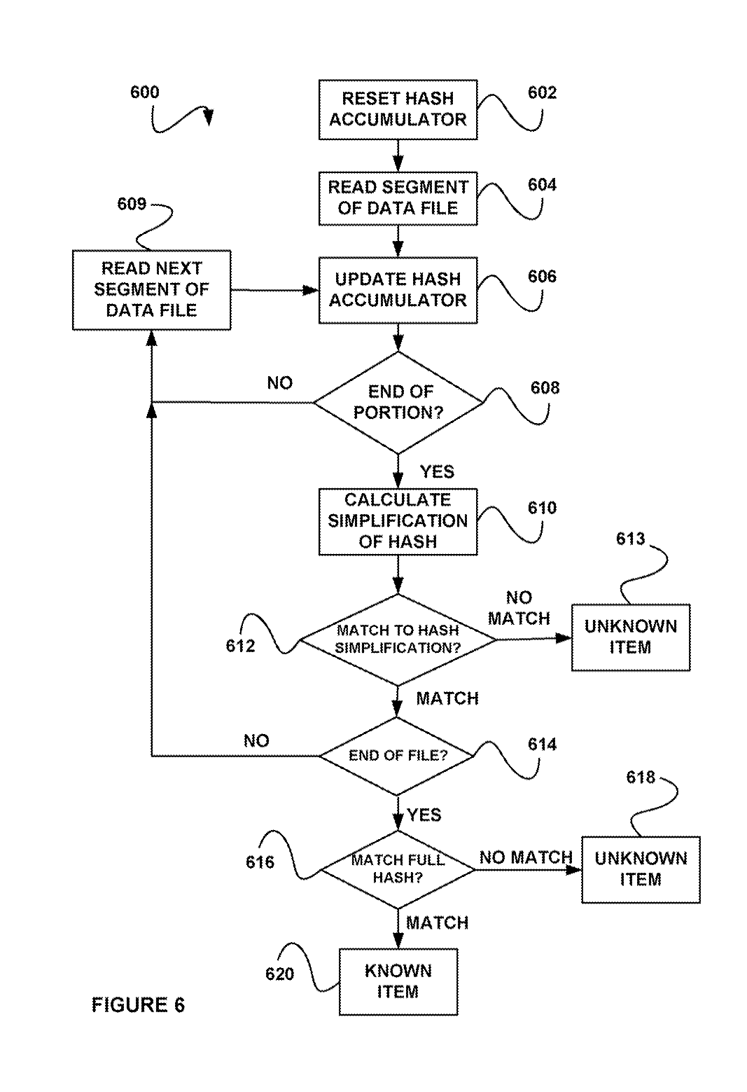

FIG. 6 shows a method 600 for identifying a data file using one or more partial hashes, in accordance with another embodiment. As an option, the method 600 may be carried out in the context of the architecture and environment of FIGS. 1-5. Of course, however, the method 600 may be carried out in any desired environment. It should also be noted that the aforementioned definitions may apply during the present description.

As illustrated in operation 602, a hash accumulator is reset. In the context of the present embodiment, the hash accumulator may include a cache or other data structure capable of storing one or more portions of a hash. Thus, resetting the hash accumulator may optionally clear any contents in the hash accumulator.

Further, in operation 604 a segment of a data file is read. The data file may be any type of file, for example, a program file, email, computer file, etc. In addition, the segment of the data file may include any part (of any size) of the data file. In one embodiment, the segment of the data file may include data within a first byte of the data file.

Additionally, in operation 606, the hash accumulator is updated. In one embodiment, the hash accumulator may be updated utilizing the segment of the data file that was read. For example, the hash accumulator may be updated by storing the segment of the data file that was read therein. Thus, the hash accumulator may include any data structure capable of storing the segment of the data file that was read.

Furthermore, in decision 608 it is determined whether a portion of the data file has been read. In one embodiment, the portion of the data file may be associated with a predetermined size. For example, it may be determined whether a size of the segment(s) of the data file for which the hash accumulator has been updated matches the predetermined portion size. In one embodiment, the predetermined portion size may be manually defined (e.g. by a user, etc.) or automatically defined (e.g. based on a total size of the data file, etc.).

If, in decision 608, it is determined that the portion of the data has not been read, a next segment of the data file is read. Note operation 609. Thus, the portion of the data file may include a plurality of segments of the data file. Moreover, the hash accumulator is updated with such next segment that was read, as shown in operation 606.

if in decision 608, it is determined that the portion of the data file has been read, a simplification is calculated for the contents of the hash accumulator. Note operation 610. As described above, the hash accumulator may have stored therein a portion of the data file which includes at least one segment of such data file. Thus, in one optional embodiment, the simplification may include determining a partial hash for the portion of the data file stored in the hash accumulator. For example, the simplification may be generated utilizing a cyclic, redundancy check (CRC), a checksum, etc. Of course, such a simplification may be generated in any desired manner.

Table 1 illustrates one example of an amount of elimination that may be achieved in relation to the size of the simplification, it should be noted that the eliminations shown are set forth for illustrative purposes only, and thus should not be construed as limiting in any manner.

TABLE 1

| Size of simplification | Amount of elimination |
|---|---|
| 1 byte | 1 in 256 |
| 2 bytes | 1 in 65536 |
| 4 bytes | 1 in 4294967296 |

In this way, a simplification may be calculated such that all of the hits in the simplification may be a representation of the portion of the data file. Accordingly, a simplification for the portion of the data file may be calculated by taking the first 1, 2, 4, etc. bytes of the hash accumulator value representative of such portion. As an option, the simplification may be stored in an array S associated with the data file. For example, the simplification associated with the first portion of the data file read may be stored in a first element (S[1]) of the array. As another option, the simplification may be identified from the array by identifying a state thereof (state.S[1]).

Further, in decision 612, it is determined whether the simplification matches a known partial hash. For example, the simplification may be compared with a plurality of known partial hashes stored in a hash database. Table 2 illustrates one example of a query utilized for determining whether the simplification matches a known partial hash. It should be noted that such query is set forth for illustrative purposes only, and thus should not be construed as limiting in any manner.

TABLE 2

SELECT * FROM HASHDatabase WHERE colS1 == state.S[1]
INTO State1

Still yet, in an optional embodiment, a partial simplification (partial.S[1], partial.S[2]) may include a range of values in the hash database which include records, where record.S[1]=partial.S[1] AND record.S[2] partial.S[2]. A partial simplification may be found in the hash database using a search (e.g. a binary search, etc.) in the hash database, which may provide upper and lower bounds for possible values. If the lower and upper bounds meet, there may not necessarily be associated records, such that it may be determined that no match for the data file is found.

Additionally, if it is determined in decision 612 that the simplification does not, match any of the known partial hashes, a signal is output indicating that the data file is identified as being unknown. Note operation 613. Just by way of example, with respect to the query in Table 2, if none of the known partial hashes match the simplification, execution of the query may result in an empty result. The unknown result may optionally indicate that data file has been altered, is or is not necessarily) infected with a virus, is (or is not necessarily) confidential, etc.

If it is determined in decision 612 that the simplification matches at least one of the known partial hashes, it is determined whether an end of the data file has been reached. Note decision 614 if the end of the data file has not been reached, at least one next segment of the data file is read (operation 609), such that a next simplification associated with a next portion of the data file may be compared to known partial hashes. See, again, operations 606-610. Optionally, the next simplification may be stored in a next element of the array S associated with the data file.

Furthermore, the next simplification may be compared to a plurality of known partial hashes that are different than the known partial hashes compared to the first simplification. For example, the different known partial hashes may be associated with only known data files for which known partial hashes matched the first simplification. Table 3 illustrates one example of a query utilized for determining whether a next portion of the data file matches a known partial hash. Similarly, such determination may be made for any subsequent portion of the data file. Again, it should be noted that the query below is set forth for illustrative purposes only, and thus should not be construed as limiting in any manner.

TABLE 3
SELECT * FROM HASHDatabase WHERE colS1 == state.S[1] AND
colS2 == state.S[2] INTO State2

Accordingly, if it is determined in decision 614 that the end of the data file has been reached, it is determined whether a hash of the entire data file matches a hash of a known data file. For example, the hash of the entire data file may be compared with one or more known full hashes of data files stored in the hash database.

If it is determined in decision 616 that the hash of the entire data file does not match a hash of a known data file, a signal is output indicating that the data file is identified as unknown. Note operation 618. If it is determined in decision 616 that the hash of the entire data file matches at least one of the hashes of a known data file, a signal is output indicating the data file is identified as known. Note operation 620. Optionally, identifying the data file as known may indicate that the data file has not necessarily been altered, that the data file is (or is not necessarily) infected with a virus, etc.

In this way, it may be determined whether the data file is known based on both the partial hashes associated with the data file and the hash of the entire data file. For example, the hash database may store known partial hashes p1, p2, p3, p4 . . . , pm along with a known full hash “f” of a particular known data file. Further, partial hashes P1, P2, P3, P4 . . . , PN may be calculated for the data file yet to be identified as known or unknown.

In one embodiment, m>=N, such that the particular known file is associated with more known partial hashes than the number of partial hashes associated with the data file yet to be identified as known or unknown, in the context of such embodiment, the data file may be identified as unknown if any of p1=P1, p2=P2, p3=P3 . . . , pN=PN are not true (i.e. any of the known partial hashes in the hash database do not match the partial hashes of the data file).

In another embodiment, m=N, such that the particular known file is associated with the same number of known partial hashes as the number of partial hashes associated with the data file yet to be identified as known or unknown. In the context of this embodiment, a hash “F” of the entire data file may additionally be compared with a known full hash “f” of the known data file. Thus, the data file may be identified as unknown if any of p1=P1, p2=P2, p3=P3 . . . , pm=PM, and f=F are not true (i.e. any of the known partial hashes in the hash database do not match the partial hashes of the data file and/or the known full hash in the hash database does not match the hash of the entire data file).

In one exemplary embodiment, the method 600 may be utilized to scan an email message. For example, when an email message is received, and optionally in response to opening the email message, the contents of the email message may be apportioned into segments, which may be sequentially hashed utilizing a hash accumulator. Optionally, when the hash accumulator contains a predefined portion of the email message, a simplification of the hashed portion may be calculated, and this simplification may be compared against known partial hashes. If the simplification matches a known partial hash, the accumulator may calculate a hash of the next email segment and may repeat comparing simplifications of each portion of the email to known partial hashes, as described above, if any of the simplifications fail to match a known partial hash, a signal may be output indicating that the email message is unknown.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

1. A method, comprising:
determining a partial hash of a first portion of data;
comparing the partial hash with a plurality of known partial hashes;
determining an additional partial hash of another portion of the data if the partial hash matches at least one of the plurality of known partial hashes, wherein the another portion of the data includes the first portion of the data and a second portion of data continuous with the first portion of the data;
comparing the additional partial hash with additional known partial hashes that are different from the plurality of known partial hashes; and
outputting a signal based on results of the comparing the additional partial hash.

2. The method of claim 1, wherein the data includes a computer file.

3. The method of claim 1, wherein the plurality of known partial hashes are stored in a database.

4. The method of claim 1, wherein the plurality of known partial hashes are stored in an array.

5. The method of claim 1, wherein the plurality of known partial hashes are generated utilizing portions of known data.

6. The method of claim 5, wherein the known data is associated with at least one predefined category of data.

7. The method of claim 5, wherein the known data includes confidential data.

8. The method of claim 5, wherein the known data includes data associated with a computer virus.

9-10. (canceled)

11. The method of claim 1, wherein the first portion of the data has a predetermined size.

12-13. (canceled)

14. The system of claim 19, wherein the system does not determine the additional partial hash if the partial hash does not match any of the plurality of known partial hashes.

15-16. (canceled)

17. The method of claim 1, further comprising
comparing a hash of an entirety of the data file with a plurality of known full hashes.

18. A computer program product embodied on a non-transitory computer readable medium for performing operations comprising:
determining a partial hash of a first portion of data;
comparing the partial hash with a plurality of known partial hashes;
determining an additional partial hash of another portion of the data if the partial hash matches at least one of the plurality of known partial hashes, wherein the another portion of the data includes the first portion of the data and a second portion of data continuous with the first portion of the data;
comparing the additional partial hash with additional known partial hashes that are different from the plurality of known partial hashes; and
outputting a signal based on results of the comparing the additional partial hash.

19. A system, comprising:
a processor, wherein the system is configured to
determine a partial hash of a first portion of data,
compare the partial hash with a plurality of known partial hashes,
determine an additional partial hash of another portion of the data if the partial hash matches at least one of the plurality of known partial hashes, wherein the another portion of the data includes the first portion of the data and a second portion of data continuous with the first portion of the data,
compare the additional partial hash with additional known partial hashes that are different from the plurality of known partial hashes, and
output a signal based on results of comparing the additional partial hash with the additional known partial hashes.

20. The system of claim 19, further comprising
memory coupled to the processor via a bus.

21. (canceled)

22. The method of claim 1, wherein the additional known partial hashes that are different from the plurality of known partial hashes include only those partial hashes associated with known data where the partial hash matches at least one of the plurality of known partial hashes.

23. The method of claim 1, wherein the comparing of the partial hash with the plurality of known partial hashes is used to determine whether the data has a confidential status.

24. The method of claim 1, wherein the known partial hashes are generated from files categorized as confidential or as associated with data relating to a computer virus or to email spam data.

25. The computer program product of claim 18, wherein the known partial hashes are generated from files categorized as confidential or as associated with data relating to a computer virus or to e-mail spam data.

26. The system of claim 19, wherein the known partial hashes are generated from files categorized as confidential or as associated with data relating to a computer virus or to e-mail spam data.

27. The method of claim 1, wherein the signal is indicative of whether an e-mail, which includes the data, is known, unknown, altered, or corrupted.
